(19) United States
(12) Patent Application Publication
(10) Pub. No.: US 2026/0222889 A1
(43) Pub. Date: Jul. 30, 2026

(54) METHODS AND APPARATUSES FOR A CONGESTION HANDLING ENCHANTMENT MECHANISM

(71) Applicant: LENOVO (BEIJING) LIMITED, Beijing (CN)

(72) Inventors: Xiaoying Xu, Shanghai (CN); Mingzeng Dai, Shanghai (CN); Lianhai Wu, Beijing (CN)

(21) Appl. No.: 19/145,524

(22) PCT Filed: Jan. 6, 2023
(86) PCT No.: PCT/CN2023/071099

§ 371 Date: Jul. 3, 2025

(51) Int. Cl. H04W 28/02; H04L 47/12; H04L 47/32

(52) U.S. Cl. CPC H04W 28/0215; H04L 47/12; H04L 47/32

(57) ABSTRACT

Embodiments of the present application relate to methods and apparatuses for a congestion handling enchantment mechanism for extended reality (XR) traffic. According to an embodiment of the present application, a network node includes a transceiver and a processor coupled to the transceiver, and the processor is configured to cause the network node to: receive capability information of a user equipment (UE), wherein the capability information includes discarding a type of protocol data unit (PDU) set or detecting an uplink (UL) congestion level; and transmit, to the UE, configuration information to discard the type of PDU set within multiple types of PDU sets.

### TECHNICAL FIELD

Embodiments of the present application generally relate to wireless communication technology, especially to methods and apparatuses for a congestion handling enchantment mechanism for extended reality (XR) traffic.

### BACKGROUND

Extended reality (XR), including augmented reality (AR) and virtual reality (VR), as well as cloud gaming (CG), presents a new promising category of connected devices, applications, and services. As a potential working area of 3GPP (3rd generation partnership project) Rel-18, power saving of a XR device is one of key topics. Currently, details regarding a congestion handling enhancement mechanism for XR traffic have not been discussed yet.

### SUMMARY

Some embodiments of the present application provide a network node. The network node includes a transceiver and a processor coupled to the transceiver; and the processor is configured to cause the network node to: receive capability information of a user equipment (UE), wherein the capability information includes discarding a type of protocol data unit (PDU) set or detecting an uplink (UL) congestion level; and transmit, to the UE, first configuration information to discard the type of PDU set within multiple types of PDU sets.

In some embodiments, the type of PDU set is carried on a logical channel (LCH) or a data radio bearer (DRB).

In some embodiments, the first configuration information indicates at least one of the following: an activated or deactivated status of discarding the type of PDU set; a PDU set type to be discarded; or an importance level of a PDU set to be discarded.

In some embodiments, the processor is configured to cause the network node to transmit a first command to the UE, to activate or deactivate discarding the type of PDU set.

In some embodiments, the first command is included in at least one of the following: a medium access control (MAC) control element (CE); a packet data convergence protocol (PDCP) control PDU; a radio link control (RLC) control PDU; downlink control information (DCI); or radio resource control (RRC) signalling.

In some embodiments, the first command includes at least one of the following: information for indicating the LCH or the DRB to apply the first command; an identifier (ID) of the LCH; an ID of the DRB; an activated or deactivated status of discarding the type of PDU set; a PDU set type to be discarded; an importance level of a PDU set to be discarded; a time length of discarding the type of PDU set; an activated or deactivated status of discarding the type of PDU set carried on a DRB within one or more DRBs; a first packet data convergence protocol (PDCP) sequence number (SN) or a first PDU set ID according to which discarding the type of PDU set is activated; or a second PDCP SN or a second PDU set ID according to which discarding the type of PDU set is deactivated.

In some embodiments, the processor is configured to cause the network node to: detect a UL congestion level; and transmit a first indication for indicating the UL congestion level to the UE.

In some embodiments, the first indication is included in at least one of the following: a medium access control (MAC) control element (CE); a service data adaptation protocol (SDAP) control PDU; a packet data convergence protocol (PDCP) control PDU; a radio link control (RLC) control PDU; or an internet protocol (IP) packet.

In some embodiments, the processor is configured to cause the network node to transmit second configuration information regarding detecting the UL congestion level to the UE.

In some embodiments, at least one of the first configuration information or the second configuration information is included in radio resource control (RRC) signalling.

In some embodiments, the second configuration information includes at least one of the following: an activated or deactivated status of detecting the UL congestion level; a set of thresholds associated with detecting the UL congestion level; or one or more lengths of a set of timers associated with detecting the UL congestion level.

In some embodiments, the processor is configured to cause the network node to transmit a command to activate detecting the UL congestion level to the UE.

Some embodiments of the present application provide a user equipment (UE). The UE includes a transceiver and a processor coupled to the transceiver; and the processor is configured to cause the UE to: receive, from a network node, first configuration information to discard a type of protocol data unit (PDU) set within multiple types of PDU sets; and determine whether to activate discarding the type of PDU set based on the first configuration information.

In some embodiments, the type of PDU set is carried on a logical channel (LCH) or a data radio bearer (DRB).

In some embodiments, wherein the first configuration information indicates at least one of the following: an activated or deactivated status of discarding the type of PDU set; a PDU set type to be discarded; or an importance level of a PDU set to be discarded.

In some embodiments, the processor is configured to cause the UE to receive a first command to activate or deactivate discarding the type of PDU set from the network node.

In some embodiments, the first command is included in at least one of the following: a medium access control (MAC) control element (CE); a packet data convergence protocol (PDCP) control PDU; a radio link control (RLC) control PDU; downlink control information (DCI); or radio resource control (RRC) signalling.

In some embodiments, the first command includes at least one of the following: information for indicating the LCH or the DRB to apply the first command; an identifier (ID) of the LCH; an ID of the DRB; an activated or deactivated status of discarding the type of PDU set; a PDU set type to be discarded; an importance level of a PDU set to be discarded; time length of discarding the type of PDU set; an activated or deactivated status of discarding the type of PDU set carried on a DRB within one or more DRBs; a first packet data convergence protocol (PDCP) sequence number (SN) or a first PDU set ID according to which discarding the type of PDU set is activated; or a second PDCP SN or a second PDU set ID according to which discarding the type of PDU set is deactivated.

In some embodiments, in response to activating discarding the type of PDU set, the processor is configured to cause a PDCP entity of the UE to discard at least one of the following: a first PDU set not submitted to one or more RLC entities of the UE; or a second PDU set a part of which has been submitted to the one or more RLC entities of the UE.

In some embodiments, the processor is configured to cause the PDCP entity of the UE to notify the one or more RLC entities of the UE to discard at least one of the following: a first RLC service data unit (SDU) of the second PDU set, wherein the first RLC SDU has not been submitted to a MAC entity of the UE; or a second RLC SDU of the second PDU set, wherein a part of the second RLC SDU has been submitted to the MAC entity of the UE.

In some embodiments, the processor is configured to cause the UE to receive a first indication for indicating an uplink (UL) congestion level from the network node.

In some embodiments, the processor is configured to cause the UE to activate discarding the type of PDU set based on the first indication.

In some embodiments, the processor is configured to cause the UE to receive a second indication for indicating the UL congestion level from the network node.

In some embodiments, the processor is configured to cause the UE to deactivate discarding the type of PDU set based on the second indication.

In some embodiments, at least one of the first indication or the second indication is included in at least one of the following: a medium access control (MAC) control element (CE); a service data adaptation protocol (SDAP) control PDU; packet data convergence protocol (PDCP) control PDU; a radio link control (RLC) control PDU; or an internet protocol (IP) packet.

In some embodiments, the processor is configured to cause the UE to receive second configuration information regarding detecting a UL congestion level from the network node.

In some embodiments, at least one of the first configuration information or the second configuration information is included in radio resource control (RRC) signalling.

In some embodiments, the second configuration information includes at least one of the following: an activated or deactivated status of detecting the UL congestion level; a set of thresholds associated with detecting the UL congestion level; or one or more lengths of a set of timers associated with detecting the UL congestion level.

In some embodiments, the processor is configured to cause the UE to receive a command to activate detecting the UL congestion level from the network node.

In some embodiments, the processor is configured to cause the UE to detect the UL congestion level based on the second configuration information, and whether to activate discarding the type of PDU set is further determined based on the UL congestion level.

In some embodiments, the processor is configured to cause the UE to deactivate discarding the type of PDU set based on the UL congestion level.

Some embodiments of the present application provide a network node. The network node includes a transceiver and a processor coupled to the transceiver; and the processor is configured to cause the network node to: receive capability information of a user equipment (UE), wherein the capability information includes prioritizing a type of protocol data unit (PDU) set; and transmit, to the UE, first configuration information to prioritize the type of PDU set.

In some embodiments, the type of PDU set is carried on a logical channel (LCH) or a data radio bearer (DRB).

In some embodiments, the first configuration information indicates at least one of the following: an activated or deactivated status of prioritizing the type of PDU set; a PDU set type to be prioritized; or an importance level of a PDU set to be prioritized.

In some embodiments, the processor is configured to cause the network node to transmit a first command to the UE, to activate or deactivate prioritizing the type of PDU set.

In some embodiments, the first command is included in at least one of the following: a medium access control (MAC) control element (CE); a packet data convergence protocol (PDCP) control PDU; a radio link control (RLC) control PDU; downlink control information (DCI); or radio resource control (RRC) signalling.

In some embodiments, the first command includes at least one of the following: information for indicating the LCH or the DRB to apply the first command; an identifier (ID) of the LCH; an ID of the DRB; an activated or deactivated status of prioritizing the type of PDU set; a PDU set type to be prioritized; an importance level of a PDU set to be prioritized; a time length of prioritizing the type of PDU set; an activated or deactivated status of prioritizing the type of PDU set carried on a DRB within one or more DRBs; a first packet data convergence protocol (PDCP) sequence number (SN) or a first PDU set ID according to which prioritizing the type of PDU set is activated; or a second PDCP SN or a second PDU set ID according to which prioritizing the type of PDU set is deactivated.

In some embodiments, the processor is configured to cause the network node to transmit second configuration information regarding detecting an uplink (UL) congestion level to the UE.

In some embodiments, at least one of the first configuration information or the second configuration information is included in radio resource control (RRC) signalling.

In some embodiments, the second configuration information includes at least one of the following: an activated or deactivated status of detecting the UL congestion level; a set of thresholds associated with detecting the UL congestion level; or one or more lengths of a set of timers associated with detecting the UL congestion level.

In some embodiments, the processor is configured to cause the network node to transmit a command to activate detecting the UL congestion level to the UE.

Some embodiments of the present application provide a user equipment (UE). The UE includes a transceiver and a processor coupled to the transceiver; and the processor is configured to cause the UE to: receive first configuration information to prioritize a type of protocol data unit (PDU) set from a network node; and determine whether to activate prioritizing the type of PDU set based on the first configuration information.

In some embodiments, the type of PDU set is carried on a logical channel (LCH) or a data radio bearer (DRB).

In some embodiments, the first configuration information indicates at least one of the following: an activated or deactivated status of prioritizing the type of PDU set; a PDU set type to be prioritized; or an importance level of a PDU set to be prioritized.

In some embodiments, the processor is configured to cause the UE to receive a first command to activate or deactivate prioritizing the type of PDU set from the network node.

In some embodiments, the first command is included in at least one of the following: a medium access control (MAC) control element (CE); a packet data convergence protocol (PDCP) control PDU; a radio link control (RLC) control PDU; downlink control information (DCI); or radio resource control (RRC) signalling.

In some embodiments, the first command includes at least one of the following: information for indicating the LCH or the DRB to apply the first command; an identifier (ID) of the LCH; an ID of the DRB; an activated or deactivated status of prioritizing the type of PDU set; a PDU set type to be prioritized; an importance level of a PDU set to be prioritized; a time length of prioritizing the type of PDU set; an activated or deactivated status of prioritizing the type of PDU set of a DRB within one or more DRBs; a first packet data convergence protocol (PDCP) sequence number (SN) or a first PDU set ID according to which prioritizing the type of PDU set is activated; or a second PDCP SN or a second PDU set ID according to which prioritizing the type of PDU set is deactivated.

In some embodiments, in response to activating prioritizing the type of PDU set, the processor is configured to cause the UE to perform at least one of the following: setting a higher priority to a first PDU set carried on the LCH or the DRB than a second PDU set carried on the LCH or the DRB; setting a prioritize bit rate of the second PDU set with a first original value to a first value; or setting a bucket size duration of the second PDU set with a second original value to a second value.

In some embodiments, the processor is configured to cause the UE to perform at least one of the following: updating priorities of the first PDU set and the second PDU set; resetting the prioritize bit rate of the second PDU set to the first original value; or resetting the bucket size duration of the second PDU set to the second original value.

In some embodiments, the processor is configured to cause the UE to receive second configuration information regarding detecting an uplink (UL) congestion level from the network node.

In some embodiments, at least one of the first configuration information or the second configuration information is included in radio resource control (RRC) signalling.

In some embodiments, the second configuration information includes at least one of the following: an activated or deactivated status of detecting the UL congestion level; a set of thresholds associated with detecting the UL congestion level; or one or more lengths of a set of timers associated with detecting the UL congestion level.

In some embodiments, the processor is configured to cause the UE to receive a command to activate detecting the UL congestion level from the network node.

In some embodiments, the processor is configured to cause the UE to detect the UL congestion level based on the second configuration information, and whether to activate prioritizing the type of PDU set is further determined based on the UL congestion level.

In some embodiments, the processor is configured to cause the UE to deactivate prioritizing the type of PDU set based on the UL congestion level.

Some embodiments of the present application provide a method performed by a network node. The method includes: receiving capability information of a user equipment (UE), wherein the capability information includes discarding a type of protocol data unit (PDU) set or detecting an uplink (UL) congestion level; and transmitting, to the UE, first configuration information to discard the type of PDU set within multiple types of PDU sets.

Some embodiments of the present application provide a method performed by a UE. The method includes: receiving, from a network node, first configuration information to discard a type of protocol data unit (PDU) set within multiple types of PDU sets; and determining whether to activate discarding the type of PDU set based on the first configuration information.

Some embodiments of the present application provide a method performed by a network node. The method includes: receiving capability information of a user equipment (UE), wherein the capability information includes prioritizing a type of protocol data unit (PDU) set; and transmitting, to the UE, first configuration information to prioritize the type of PDU set.

Some embodiments of the present application provide a method performed by a UE. The method includes: receiving first configuration information to prioritize a type of protocol data unit (PDU) set from a network node; and determining whether to activate prioritizing the type of PDU set based on the first configuration information.

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a UE or a network node (e.g., a base station (BS)).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary diagram of important and unimportant PDU sets in an XR traffic stream in accordance with some embodiments of the present application.

FIG. 3 illustrates an exemplary diagram of mapping alternatives of PDU sets in accordance with some embodiments of the present application.

FIG. 4 illustrates an exemplary flowchart of transmitting configuration information regarding discarding a PDU set in accordance with some embodiments of the present application.

FIGS. 5A-5C illustrate exemplary diagrams of a command to activate or deactivate discarding a PDU set in accordance with some embodiments of the present application.

FIG. 6 illustrates an exemplary flowchart of receiving configuration information regarding discarding a PDU set in accordance with some embodiments of the present application.

FIGS. 7 and 8 illustrate exemplary flowcharts of a congestion handling enchantment mechanism in accordance with some embodiments of the present application.

FIG. 9 illustrates an exemplary flowchart of transmitting configuration information regarding prioritizing a PDU set in accordance with some embodiments of the present application.

FIG. 10 illustrates an exemplary diagram of prioritizing a PDU set in accordance with some embodiments of the present application.

FIG. 11 illustrates an exemplary flowchart of receiving configuration information regarding prioritizing a PDU set in accordance with some embodiments of the present application.

FIG. 12 illustrates a block diagram of an exemplary apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

FIG. 1 illustrates a schematic diagram of a wireless communication system in accordance with some embodiments of the present application. As shown in FIG. 1, the wireless communication system 100 includes at least one base station (BS) 101 and at least one user equipment (UE) 102. In particular, the wireless communication system 100 includes one BS 101 and two UE 102 (e.g., UE 102a and UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

BS 101 may communicate with a core network (CN) node (not shown), e.g., a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a RAN node or network apparatus. Each BS may serve a number of UE(s) within a serving area, for example, a cell or a cell sector via a wireless communication link. Neighbour BSs may communicate with each other as necessary, e.g., during a handover procedure for a UE.

UE 102, e.g., UE 102a and UE 102b, should be understood as any type terminal device, which may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, UE 102 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, UE 102 may include wearable devices, such as smart watches, fitness bands, optical head-mounted displays, or the like. Moreover, UE 102 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 102 may communicate directly with BSs 101 via uplink (UL) communication signals.

Typically, XR, including AR and VR, as well as Cloud Gaming (CG), presents a new promising category of connected devices, applications, and services. A PDU set and quality of service (QoS) characteristics of a PDU set have been introduced for XR service. In general, a PDU set is composed of one or more PDUs carrying the payload of one unit of information generated at the application level (e.g., a frame or video slice for XR and media (XRM) services). In some implementations, all PDUs in a PDU set are needed by the application layer to use the corresponding unit of information. In other implementations, the application layer can still recover a part of or the entire information unit, when some PDUs are missing. PDU sets can carry different content with different importance levels, e.g., I-Frames, B-Frames, or P-Frames, P-slices or I-slices (e.g., slices/tiles within an I-Frame, a B-Frame, or a P-Frame), and etc.

In some embodiments of the present application, PDU set types can be characterised by the PDU set's importance level. In an embodiment, there are two PDU set types, one is important PDU set type, and the other is unimportant PDU set type. In another embodiment, there may be PDU set types characterized by multiple importance levels, e.g., importance level #1, importance level #2 importance level #3, importance level #4, and etc.; or high importance level and less importance level. For example, 10 is highest importance level, 1 is the lowest importance level.

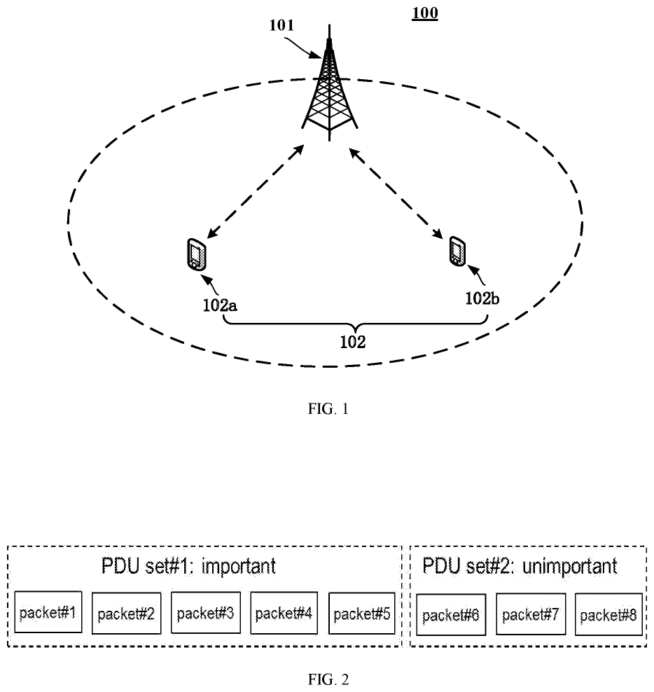

A PDU set type may be characterized by a notion of “importance” indicating how important the PDU set (e.g., a video frame) is for the application. For example, an important PDU set could be an I-Frame within a burst or I-slice within a frame, while an unimportant PDU set could be a P-Frame within a burst or a P-slice within a frame. A specific example is described in the embodiments of FIG. 2 as follows. In some other embodiments of the present application, PDU set types can be characterised by the PDU set's other parameters or characters.

FIG. 2 illustrates an exemplary diagram of important and unimportant PDU sets in an XR traffic stream in accordance with some embodiments of the present application. PDU set type #1 is important and may include packet #1, packet #2, packet #3, packet #4, and packet #5. PDU set type #2 is unimportant and may include packet #6, packet #7, and packet #8.

In general, regarding PDU set dropping or PDU set discarding, a mechanism is evaluating whether to drop or discard PDU set(s) based on a bit rate, a PDU set size, and packet delay budget (PDB)/PDU set delay budget or latency left (e.g., PDB/PSDB is the queued time). AS specified in 3GPP TR 38.835, regarding PDU Set Delay Budget (PSDB): time between reception of the first PDU and the successful delivery of the last arrived PDU of a PDU Set (see TR 23.700-60 [9]). A network node can evaluate, using buffer status report (BSR) information and timing indications (if provided, or else estimated), whether it can provide grants to complete the transmission in the indicated time. If the network node cannot provide the grants, the network node may indicate to the UE to drop or discard PDU set(s). The PDU set size, the PSDB, the PDB (or latency left), and the statistical bit rate can also be known at the UE. Additional configuration parameters could be provided to the UE. Then, the UE could decide when to drop or discard the PDU set(s).

As specified in 3GPP TS 38.323, regarding a transmission operation, at reception of a PDCP SDU from upper layers, the transmitting PDCP entity of a UE shall start the discardTimer associated with this PDCP SDU (if configured). Regarding SDU discarding, when the discardTimer expires for a PDCP SDU, or the successful delivery of a PDCP SDU is confirmed by a PDCP status report, the transmitting PDCP entity of the UE shall discard the PDCP SDU along with the corresponding PDCP data PDU. If the corresponding PDCP data PDU has already been submitted to lower layer(s) of the UE, the discarding indication is indicated to the lower layer(s). For signalling radio bearers (SRB) s, when upper layer(s) of the UE request a PDCP SDU discarding, the PDCP entity of the UE shall discard all stored PDCP SDUs and PDCP PDUs.

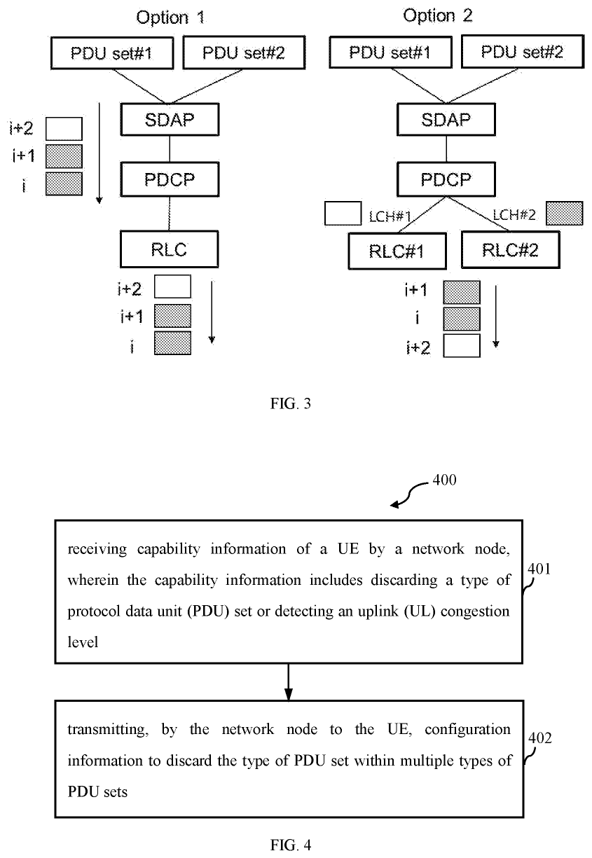

Currently, an issue of whether different types of PDU sets can be mapped to different RLC entities of one DRB to support different QoS handling needs to be solved, e.g., as described in the embodiments of FIG. 3 as follows.

FIG. 3 illustrates an exemplary diagram of mapping alternatives of PDU sets in accordance with some embodiments of the present application. In the embodiments of FIG. 3, PDU set #1 is of one PDU set type (e.g., important PDU set type) and include PDU set i+2. PDU set #2 is of another PDU set type (e.g., unimportant PDU set type) and include PDU set i+1 and PDU set i. Regarding PDU set #1 and PDU set #2 orderly submitted to SDAP and PDCP entities of a UE, e.g., the arrival order is PDU set i, PDU set i+1, and PDU set i+2 as shown in FIG. 3, there are two options of mapping alternatives between PDU set type and LCH/RLC entity of the UE, i.e., Option 1 and Option 2 as below.

Option 1 as shown in FIG. 3 uses legacy DRB with one RLC entity, in which PDU set i, PDU set i+1, and PDU set i+2 are orderly submitted by the PDCP entity to one RLC entity, i.e., one LCH. In Option 1, an issue is that the UE does not prioritize the transmission of the PDU sets than the arrival order. In case of UL congestion, the UE cannot prioritize the transmission of important PDU set(s), e.g., PDU set i+2, due to which a user's experience cannot be improved.

Option 2 as shown in FIG. 3 uses a new type of DRB configured with at least two RLC entities or two LCHs (each for one PDU set type). For instance, the “important” PDU set #1 like I-frame (e.g., PDU set i+2) is submitted to LCH #1 (e.g., with logical channel id1 (LCID)1) with a higher priority, i.e., RLC #1 entity. The “unimportant” PDU set #2 (e.g., PDU set i and PDU set i+1) is submitted to LCH #2 (e.g., with LCID2) with a lower priority, i.e., RLC #2 entity. Then, the order of the PDU sets are changed, and PDU set i+2 is firstly transmitted prior to PDU set i and PDU set i+1. In Option 2, an issue is that the UE prioritizes the transmission of important PDU set(s) compared with the arrival order, i.e., the later arrival important PDU set i+2 which is mapped to LCH #1 will be transmitted before the earlier arrival unimportant PDU set i or PDU set i+1 which are mapped to LCH #2, and it will unnecessarily delay the transmissions of PDU set i and PDU set i+1, and thus will impact a user's experience.

Embodiments of the present application aim to solve the issues in Option 1 and Option 2 as shown in FIG. 3 including: how to prioritize the transmission for multiple PDU set types over air interface in case of UL congestion, how to support PDU set discarding with multiple types of PDU sets in PDCP/RLC entity, how to handle multiple PDU set types during logical channel prioritization (LCP), and how to determine a UL congestion level at a UE. In some embodiments of the present application, a UL congestion level may also be named as “a UL congestion status” or the like.

More specifically, some embodiments of the present application provide a congestion handling enhancement mechanism for data transmissions for multiple PDU set types for XR traffic. In some embodiments of present application, a UE discards one type of PDU set on a DRB/LCH based on the discard indication or the UL congestion level detected by a network node or based on the UL congestion level detected at the UE. In some embodiments of present application, a UE prioritizes the data transmission of a PDU set type and/or switches parameters (e.g., the prioritisedBitRate and/or bucketSizeDuration) of other PDU set types according to a dynamic indication from a network node or a UL congestion level detected at the UE. In some embodiments of present application, a UE performs the UL congestion level determination based on the criteria received from a network node. For instance, the criteria may include a count value of the consecutive number of discarded PDU sets or discarded PDCP SDUs, a buffer size or a timer for detecting UL congestion level. More details will be illustrated in following text in combination with the appended drawings.

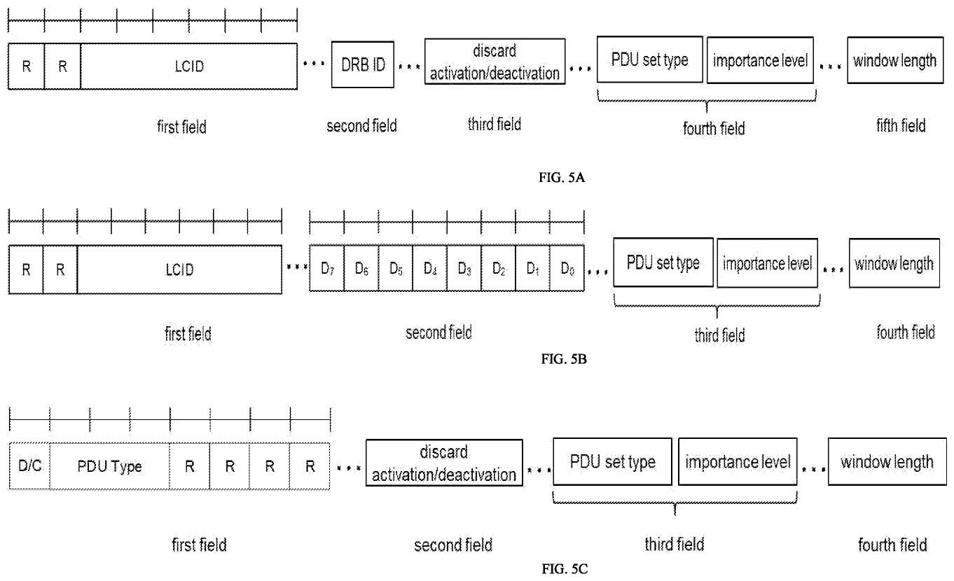

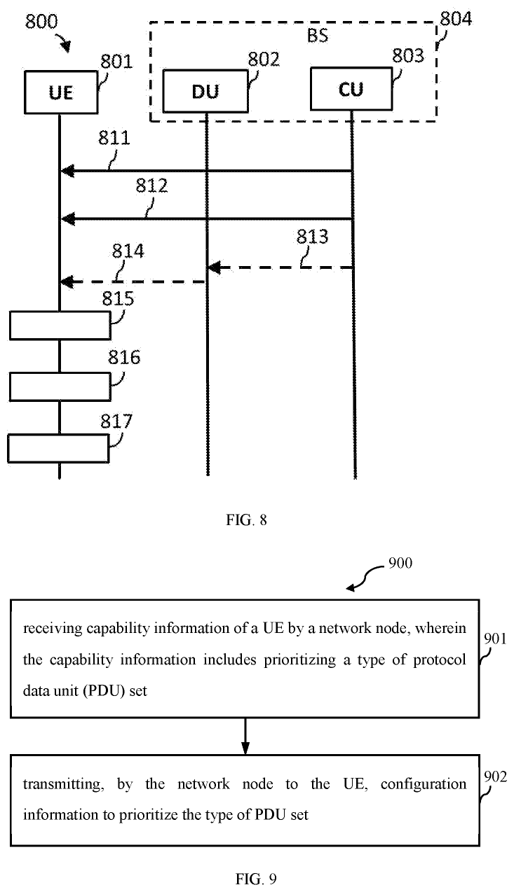

FIG. 4 illustrates an exemplary flowchart of transmitting configuration information regarding discarding a PDU set in accordance with some embodiments of the present application. The exemplary method 400 in the embodiments of FIG. 4 may be performed by a network node (e.g., BS 101, BS 704, or BS 804 as shown and illustrated in FIG. 1, FIG. 7, or FIG. 8). Although described with respect to a network node, it should be understood that other devices may be configured to perform a method similar to that of FIG. 4. Details described in all other embodiments of the present application are applicable for the embodiments of FIG. 4. Moreover, details described in the embodiments of FIG. 4 are applicable for all the embodiments of FIGS. 1-3 and 5-12. Specific examples of exemplary method 400 are described in the embodiments of FIGS. 5A-5C, Embodiments 1~4 in the embodiments of FIG. 7, and Embodiment 5 in the embodiments of FIG. 8 as follows.

In the exemplary method 400 as shown in FIG. 4, in operation 401, a network node (e.g., BS 101 as shown in FIG. 1) may receive capability information of a UE (e.g., UE 102a as shown in FIG. 1). The capability information includes discarding a type of PDU set or detecting a UL congestion level. For example, the capability information supports a PDU set discard operation and/or a UL congestion detection operation of the UE.

In operation 402, the network node may transmit, to the UE, configuration information (denoted as configuration #1 for simplicity) to discard the type of PDU set within multiple types of PDU sets. In some embodiments, the type of PDU set is carried on one LCH of multiple LCHs of a DRB or a DRB. For example, multiple types of PDU sets may refer to PDU sets with multiple importance levels or other multiple types.

In some embodiments, configuration #1 is included in RRC signalling. For instance, configuration #1 may include at least one of the following:
(1) An activated or deactivated status/state of discarding the type of PDU set, e.g., dynamicdiscardPDUSet IE or discard status IE, values of which may be TRUE or FALSE.
(2) A PDU set type to be discarded, e.g., discardPDUSetInfo IE, for example, including important PDU set type or unimportant PDU set type.
(3) An importance level of a PDU set to be discarded, e.g., discardPDUSetimportanceLevel IE, for example, including importance level #1, importance level #2, importance level #3, or importance level #4. A specific example is described in the embodiments of FIG. 7 as follows.

In some embodiments, the network node may transmit a command (denoted as command #1 for simplicity) to the UE, to activate or deactivate discarding the type of PDU set. For instance, command #1 is included in a layer2 (L2) header, a MAC CE, PDCP control PDU, an RLC control PDU, DCI, and/or RRC signalling. For example, command #1 is included in a MAC-subheader including an assigned LCID associated with a MAC CE or a PDCP header including a PDU TYPE associated with a PDCP control PDU. In some embodiments, command #1 includes at least one of the following:
(1) Information for indicating the LCH or the DRB to apply command #1.
(2) An ID of the LCH, e.g., the LCID filed, to activate or deactivate discarding the type of PDU set.
(3) An ID of the DRB, e.g., the DRB ID filed, to activate or deactivate discarding the type of PDU set.
(4) An activated or deactivated status of discarding the type of PDU set, e.g., the discard activation/deactivation filed. For example, TRUE represents the activated status or FALSE represents the deactivated status.
(5) A PDU set type to be discarded. For example, it is important PDU set type and/or unimportant PDU set type.
(6) An importance level of a PDU set to be discarded. For example, it is importance level #1, importance level #2, importance level #3, and/or importance level #4.
(7) A time length of discarding the type of PDU set, e.g., the window length field. For example, the time length is 100 ms or 1000 ms.
(8) An activated or deactivated status of discarding the type of PDU set carried on a DRB within one or more DRBs, e.g., the Di field.
(9) A PDCP SN or a PDU set ID according to which discarding the type of PDU set is activated, e.g., a PDCP SN or PDU set ID field.
(10) A PDCP SN or a PDU set ID according to which discarding the type of PDU set is deactivated, e.g., another PDCP SN or PDU set ID field. Specific examples are described in the embodiments of FIGS. 5A-5C as follows.

In some embodiments, the network node may detect a UL congestion level, and transmit an indication (denoted as indication #1 for simplicity) for indicating the detected UL congestion level to the UE. Indication #1 may be included in a layer2 (L2) header, a MAC CE, a SDAP control PDU, a PDCP control PDU, an RLC control PDU, and/or an IP packet. If the detected UL congestion level is changed or updated, the network node may transmit another indication (denoted as indication #2 for simplicity) for indicating the updated UL congestion level to the UE. Indication #2 may be included in a layer2 (L2) header, a MAC CE, a SDAP control PDU, a PDCP control PDU, an RLC control PDU, and/or an IP packet. A specific example is described in the embodiments of FIG. 7 as follows.

In some embodiments, the network node may transmit configuration information (denoted as configuration #2 for simplicity) regarding detecting the UL congestion level to the UE. For instance, configuration #2 is included in RRC signalling. In some embodiments, configuration #2 includes at least one of the following information, for instance, such information may be the criteria of the UL congestion level included in the ULCongestionDectection IE as described in the embodiments of FIG. 8.
(1) An activated or deactivated status of detecting the UL congestion level.
(2) A set of thresholds associated with detecting the UL congestion level.
(3) Length(s) of a set of timers associated with detecting the UL congestion level.

In some embodiments, the network node may transmit a command (denoted as command #2 for simplicity) to activate detecting the UL congestion level to the UE. A specific example is described in the embodiments of FIG. 8 as follows.

FIGS. 5A-5C illustrate exemplary diagrams of a command to activate or deactivate discarding a PDU set in accordance with some embodiments of the present application.

In particular, FIG. 5A shows a MAC CE and an associated MAC-subheader carrying a command to activate or deactivate discarding a PDU set. The MAC-subheader in FIG. 5A may include:
(1) The first field: LCID, which is logical channel information assigned to identify the MAC CE.

The MAC CE in FIG. 5A may include at least one of the following:
(1) The second field: DRB ID, to which the MAC CE is applied. For example, this field is of 5 bit length and includes the DRB ID. Optionally, this field may be not included in the MAC CE. In such case, a UE may consider that the MAC CE is applied to all DRB(s) configured with the PDU set discard or applied to only the DRBs with dynamicdiscardPDUSet IE of the DRB set to TURE in the received RRC signalling.
(2) The third field: “discard activation/deactivation”, which is a discard activation or deactivation command. This field may also be named as “discard activation or deactivation status” or the like. For example, this field is of 1 bit length, wherein value 1 indicates the discard activation, and value 0 indicates the discard deactivation.
(3) The fourth field: there may be two options in different embodiments. As shown in FIG. 5A, in one option, the fourth field is “PDU set type”, which indicates the PDU set type to be discarded. In another option, the fourth field is “importance level”, which indicates the importance level of a PDU set to be discarded. The fourth field may be set in the discardPDUSetInfo IE or the discardPDUSetimportanceLevel IE in RRC signalling from a network node. Optionally, this field may be not included in the MAC CE. In such case, a UE may consider the discardPDUSetInfo IE or discardPDUSetimportanceLevel IE received in RRC signalling as the PDU set type to be discarded or the importance level to be discarded.
(4) The fifth field: window length, which indicates how long time to discard PDU set(s). This field may also be named as “time duration” or “time length” or the like. In some embodiments, the actual window length is 100 ms or 1000 ms. In some other embodiments, an index is mapped to the actual window length. For example, 1 represents “1*step” (e.g., 100 ms), 2 represents “2*step” (e.g., 200 ms), and the value of “step” may be predefined or preconfigured by RRC signalling from a network node. Optionally, this field may be not included in the MAC CE, and the actual window length is configured by RRC signalling.

FIG. 5B also shows a MAC CE and an associated MAC-subheader carrying a command to activate or deactivate discarding a PDU set. The first, third, and fourth fields in the MAC CE in FIG. 5B are the same as the first, fourth, and fifth fields in the MAC CE in FIG. 5A. Different from FIG. 5A, the MAC CE in FIG. 5B includes the second field Di with a bitmap. For example, each bit position of the bitmap represents a DRB configured with dynamicdiscardPDUSet IE.

In particular, as shown in FIG. 5B, the second field Di indicates an activation or deactivation status of the dynamic PDU set discard of DRB i, where i is the ascending order of the DRB ID among the DRBs configured with dynamicdiscardPDUSet IE and with RLC entity (ies) associated with this MAC entity. For instance, in the Di field, value 1 indicates that the PDU set discard of DRB i shall be activated, and value 0 indicates that the PDU set discard of DRB i shall be deactivated.

FIG. 5C shows a PDCP control PDU and an associated PDCP header carrying a command to activate or deactivate discarding a PDU set. The second, third, and fourth field in PDCP payload of the PDCP control PDU in FIG. 5C are the same as the third, fourth, and fifth field in the MAC CE in FIG. 5A. Different from the MAC CE in FIG. 5A, the associated PDCP header of the PDCP control PDU in FIG. 5C includes “PDU Type” to identify this PDCP control PDU.

Optionally, in the embodiments of any of FIGS. 5A-5C, the command to activate or deactivate discarding a PDU set may further include at least one of following two fields:
(1) One field: PDCP SN or PDU set ID, according to which discarding the type of PDU set is activated. For example, based on the PDCP SN or the PDU set ID in this field, a UE may start to discard PDU set(s).
(2) Another field: PDCP SN or PDU set ID, according to which discarding the type of PDU set is deactivated. For example, based on the PDCP SN or the PDU set ID in this field, a UE may stop discarding PDU set(s). These two fields may be distinct using different names or expressions, without departing from the spirit and scope of the disclosure.

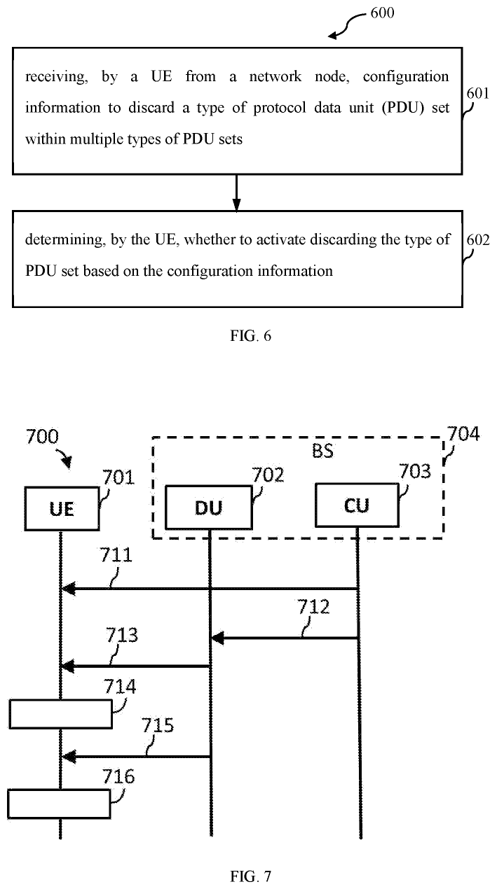

FIG. 6 illustrates an exemplary flowchart of receiving configuration information regarding discarding a PDU set in accordance with some embodiments of the present application. The exemplary method 600 in the embodiments of FIG. 6 may be performed by a UE (e.g., UE 102 as shown and illustrated in FIG. 1). Although described with respect to a UE, it should be understood that other devices may be configured to perform a method similar to that of FIG. 6. Details described in all other embodiments of the present application are applicable for the embodiments of FIG. 6. Moreover, details described in the embodiments of FIG. 6 are applicable for all the embodiments of FIGS. 1-5 and 7-12. A specific example of exemplary method 600 is described, Embodiments 1~4 in the embodiments of FIG. 7, and Embodiment 5 in the embodiments of FIG. 8 as follows.

In the exemplary method 600 as shown in FIG. 6, in operation 601, a UE (e.g., UE 102a as shown in FIG. 1) may receive, from a network node (e.g., BS 101 as shown in FIG. 1), configuration information (e.g., configuration #1 as described in the embodiments of FIG. 4) to discard a type of PDU set within multiple types of PDU sets. In some embodiments, the configuration information is received in RRC signalling. For instance, the configuration information may indicate: an activated or deactivated status of discarding the type of PDU set; a PDU set type to be discarded; and/or an importance level of a PDU set to be discarded. For example, multiple types of PDU sets may refer to PDU sets with multiple importance levels or other multiple types.

In operation 602, the UE may determine whether to activate discarding the type of PDU set based on the received configuration information. In some embodiments, the type of PDU set is carried on one LCH of multiple LCHs of a DRB or a DRB.

In some embodiments, the UE may receive a command to activate or deactivate discarding the type of PDU set (e.g., command #1 as described in the embodiments of FIG. 4) from the network node. The command may be included in a layer2 (L2) header, a MAC CE, a PDCP control PDU, an RLC control PDU, DCI, and/or RRC signalling. In some embodiments, the command includes at least one of the following:
(1) information for indicating the LCH or the DRB to apply the command;
(2) an ID of the LCH to activate or deactivate discarding the type of PDU set;
(3) an ID of the DRB to activate or deactivate discarding the type of PDU set;
(4) an activated or deactivated status of discarding the type of PDU set;
(5) a PDU set type to be discarded; an importance level of a PDU set to be discarded;
(6) time length of discarding the type of PDU set;
(7) an activated or deactivated status of discarding the type of PDU set carried on a DRB within one or more DRBs;
(8) a PDCP SN or a PDU set ID according to which discarding the type of PDU set is activated; or
(9) a PDCP SN or a PDU set ID according to which discarding the type of PDU set is deactivated. Specific examples are described in the embodiments of FIGS. 5A-5C.

In some embodiments, in response to activating discarding the type of PDU set, a PDCP entity of the UE may first identify the type of the PDU set from the upper layer and discard at least one of the following:
(1) a PDU set (denoted as PDU set1 for simplicity) which has not been submitted to RLC entity (ies) of the UE; or
(2) a PDU set (denoted as PDU set2 for simplicity) a part of which has been submitted to the RLC entity (ies) of the UE. In some embodiments, the PDCP entity of the UE may notify the RLC entity (ies) of the UE to discard at least one of the following:
   1) an RLC SDU of PDU set2, which has not been submitted to a MAC entity of the UE; or
   2) an RLC SDU of PDU set2, a part of which has been submitted to the MAC entity of the UE.

In some embodiments, the UE may receive, from the network node, an indication for indicating an UL congestion level (e.g., indication #1 as described in the embodiments of FIG. 4). The indication may be included in a layer2 (L2) header, a MAC CE, a SDAP control PDU, PDCP control PDU, an RLC control PDU, and/or an IP packet. In some embodiments, the UE may activate discarding the type of PDU set based on the indication.

In some embodiments, the UE may receive, from the network node, another indication (e.g., indication #2 as described in the embodiments of FIG. 4) for indicating the UL congestion level, which may be included in a layer2 (L2) header, a MAC CE, a SDAP control PDU, PDCP control PDU, an RLC control PDU, and/or an IP packet, and the UE may deactivate discarding the type of PDU set based on such indication. A specific example is described in the embodiments of FIG. 7 as follows.

In some embodiments, the UE may receive, from the network node, configuration information regarding detecting a UL congestion level (e.g., configuration #2 as described in the embodiments of FIG. 4), which may be included in RRC signalling. In an embodiment, the configuration information includes at least one of the following:
(1) an activated or deactivated status of detecting the UL congestion level;
(2) a set of thresholds associated with detecting the UL congestion level; or
(3) one or more lengths of a set of timers associated with detecting the UL congestion level. A specific example is described in the embodiments of FIG. 8 as follows.

In some embodiments, the UE may receive a command (e.g., command #2 as described in the embodiments of FIG. 4) to activate detecting the UL congestion level from the network node.

In some embodiments, the UE may detect the UL congestion level based on the configuration information (e.g., configuration #2 as described in the embodiments of FIG. 4), and whether to activate discarding the type of PDU set is further determined based on the UL congestion level. In some embodiments, the UE may deactivate discarding the type of PDU set based on the UL congestion level. A specific example is described in the embodiments of FIG. 8 as follows.

It should be appreciated by persons skilled in the art that the sequence of the operations in any of exemplary flowcharts 400 and 600 in FIGS. 4 and 6 described above may be changed and some of the operations in any of exemplary flowcharts 400 and 600 in FIGS. 4 and 6 may be eliminated or modified, without departing from the spirit and scope of the disclosure. Specific examples of the embodiments of FIGS. 4 and 6 are illustrated in following text in combination with FIGS. 7 and 8, i.e., Embodiment 1, Embodiment 2, Embodiment 3, Embodiment 4, and Embodiment 5.

FIG. 7 illustrates an exemplary flowchart of a congestion handling enchantment mechanism in accordance with some embodiments of the present application. The exemplary flowchart 700 as shown in FIG. 7 may refer to different embodiments in different scenarios, i.e., Embodiment 1, and Embodiment 2, Embodiment 3, and Embodiment 4 as below. Embodiment 1 and Embodiment 3 are applicable to Option 1 in FIG. 3. Embodiment 2 and Embodiment 4 are applicable to Option 2 in FIG. 3.

### Embodiment 1

In Embodiment 1, the exemplary flowchart 700 shows an example of a PDU set discard operation based on a UL PDU set discard command from a network node. In particular, UE 701 may discard a PDU set type based on dynamic discard activation signalling from the network node, e.g. BS 704. As shown in FIG. 7, BS 704 is in CU-DU architecture, and includes DU 702 and CU 703. In Embodiment 1, following operations may be performed.

In operation 711, CU 703 transmits the PDU set discard configuration (e.g., configuration #1 as described in the embodiments of FIG. 4) for a DRB (or one LCH), which carries data of a PDU set type, to UE 704 in an RRC message. For example, the RRC message may be an RRCreconfiguration message, an RRCResume message, or an RRCSetup message.

In some embodiments, the PDU set discard configuration may include an indication, e.g., dynamicdiscardPDUSet IE, which is used to enable UE 701 to discard data of a PDU set which is of a PDU set type (e.g., unimportant) and available for transmission carried on a DRB.

For example, the dynamicdiscardPDUSet IE indicates the status of the unimportant PDU set discard after receiving this IE. TRUE of this IE means that the status is activated and UE 701 may discard the PDU set type of the PDCP entity. FALSE of this IE means that the status is not activated, and UE 701 may not discard the PDU set type of the PDCP entity. In an example, dynamicdiscardPDUSet IE may be configured as follows.

| | | |
|---|---|---|
| PDCP-Config ::= | SEQUENCE { | |
| dynamicdiscardPDUSet | BOOLEAN | OPTIONAL -- Cond DRB |
| } | | |

In some embodiments, the PDU set discard configuration may include an indication, e.g., discardPDUSetInfo IE, which is used to indicate the PDU set type related to discard handling. For instance, the discardPDUSetInfo IE indicates PDU set type(s) to be discarded if the PDU set type discard is activated. For example, PDU set type #1 indicates a PDU set type with high importance level, and PDU set type #2 indicates a PDU set with less importance level. In an example, the PDU set type with high importance level is named as a primary PDU set. While the PDU set type with less importance level is named as a secondary PDU set. For example, 10 is highest importance level, while 1 is the lowest importance level.

In an embodiment, if a value of the discardPDUSetInfo IE is set to PDU set type #2, UE 701 may discard data of PDU set type #2. In an example, the discardPDUSetInfo IE may be configured as follows.

PDCP-Config ::= SEQUENCE {
discardPDUSetInfo ENUMERATED {PDUsetype#1, PDUsettype#2, spare2,
spare1} OPTIONAL -- Cond DRB
}
Note,
importance level#1 of PDU set type#1 > importance level#2 of PDU set type#2

In some other embodiments, the explicit importance level is used to identify the PDU set type. In an embodiment, if the value of the discardPDUSetimportanceLevel IE is set to importance level #2, UE 701 may discard data of the PDU set with the importance level that is equal to or lower than importance level #2. In an example, the discardPDUSetimportanceLevel IE may be configured as follows.

PDCP-Config ::= SEQUENCE {
discardPDUSetimportanceLevel INTEGER(1..10) OPTIONAL -- Cond DRB
}

In operation 712, CU 703 may transmit an indication to the DU 702 via F1AP message, to indicate that a transmission of a UL PDU set discard activation command or signalling is allowed or enabled. In operation 713, DU 702 transmits dynamic discard activation signalling (i.e., the UL PDU set discard activation command, e.g., command #1 as described in the embodiments of FIG. 4) to UE 701 to assist UE 701 to determine whether to discard data of a PDU set type. In an example, when DU 702 detects that the UL congestion level is high or not low, DU 702 may determine to send the UL PDU set discard activation command to UE 701.

In some embodiments, the signalling or command in operation 713 may indicate UE 701 to activate discarding the PDU set of the PDU set type for a DRB. Specific examples of the signalling or command are described in the embodiments of FIGS. 5A-5C.

In operation 714, after UE 701 receives the signalling to activate the PDU set discard for a DRB (i.e., the discard activation signalling for a DRB), UE 701 may start discarding data of specific PDU set type on the DRB. In some embodiments, the specific PDU set type (e.g., PDU set type #2) may be predefined by standard documents, configured by an RRC message, or indicated by the dynamic signalling from BS 704.

For example, after receiving the discard activation signalling for a DRB, the MAC entity of UE 701 may notify the discard activation command to the PDCP entity of the DRB. The PDCP entity may activate discarding the PDCP SDU(s) or PDU(s) available for transmission of the specific PDU set type (e.g., PDU set type #2). At the PDCP entity, both of a PDCP SDU and a PDCP PDU belong to a PDU set. For instance, the PDU set(s) of PDU set type #2 may include at least one of the following:
(1) The whole PDU set which has not been submitted to the RLC layer of UE 701.
(2) A part of the PDU set which has been submitted to the RLC layer of UE 701. In this case, the PDCP entity of UE 701 may notify the mapped RLC entity to discard RLC SDU(s) of PDU set type #2 and/or the whole or a part of a RLC SDU of PDU set type #2 which has not been submitted to the MAC layer.

In some embodiments of operation 714, after UE 701 receives the discard activation signalling for a DRB, the MAC entity of UE 701 may notify the discard command to the PDCP entity of the DRB. The PDCP entity may start a timer and UE 701 may discard the PDCP SDU(s) or PDU(s) which are available for transmission of the specific PDU set type till the timer expires. The timer length may be indicated in the “window length” field in the dynamic discard activation signalling as described in FIGS. 5A-5C, preconfigured by an RRC message from BS 704 or predefined in specification.

In some other embodiments of operation 714, after UE 701 receives the discard activation signalling for a DRB, the MAC entity of UE 701 may notify the discard command to the PDCP entity of the DRB. The PDCP entity may discard the PDCP SDU(s) or PDU(s) available for transmission of the specific PDU set type only once.

In operation 715, DU 702 may transmit dynamic discard deactivation signalling (e.g., command #1 as described in the embodiments of FIG. 4) to UE 701, to assist UE 701 to determine whether to stop discarding data of the PDU set type. In an example, when BS 704 detects that the UL congestion is not high or low, BS 704 may determine to send a PDU set discard deactivation command for a DRB to UE 701.

In operation 716, after UE 701 receives the dynamic discard deactivation signalling from DU 702 to deactivate the PDU set discard for a DRB, UE 701 may stop discarding data of the PDU set type on the DRB.

In some embodiments, if some PDCP SDU(s) of the PDU set has been discarded upon reception of an indication, UE 701 may discard the remaining PDCP SDU(s) of the PDU set in operation 716. For example, if a PDU set integrated indication is configured for the DRB, and the indication indicates whether all PDU(s) are needed for the usage of PDU set by application layer, and some PDCP SDU(s) of the PDU set has been discarded upon reception of the indication, UE 701 can discard the remaining PDCP SDU(s) of the PDU set.

### Embodiment 2

Embodiment 2 is similar to Embodiment 1. Embodiment 1 is applicable to Option 1 in FIG. 3. Embodiment 2 is applicable to Option 2 in FIG. 3. The operations 711, 712, 713, 715, and 716 performed in Embodiment 1 and Embodiment 2 are the same, but the operation 714 is different. Different from Embodiment 1, in operation 714 of Embodiment 2, if UE 701 receives the discard activation signalling from DU 702 to activate the PDU set discard for a DRB, UE 701 may start discarding the data of a specific PDU set type on the DRB. The specific PDU set type (e.g., PDU set type #2) may be predefined by standard documents, configured by an RRC message or indicated by the dynamic signalling from a network node.

For example, in operation 714 of Embodiment 2, after receiving the discard activation signalling or command for the DRB, the MAC entity of UE 701 may notify the discard activation signalling or command to the PDCP entity of the DRB of UE 701. The PDCP entity may activate discarding PDCP SDU(s)/PDU(s) available for transmission of the PDU set type (e.g., PDU set type #2). At the PDCP entity, both of a PDCP SDU and a PDCP PDU belong to a PDU set. For instance, the PDU set(s) of PDU set type #2 may include at least one of:
(1) The whole PDU set which has not been submitted to the RLC layer of UE 701.
(2) A part of the PDU set which has been submitted to the RLC layer of UE 701. In this case, the PDCP entity may notify the RLC entity (which carries the PDU set #2) to discard RLC SDU(s) of PDU set type #2 and/or the whole or a part of a RLC SDU of PDU set type #2 which has not been submitted to the MAC layer.

### Embodiment 3

In Embodiment 3, the exemplary flowchart 700 shows an example of a PDU set discard operation based on a UL congestion level from a network node. In particular, UE 701 may discard a PDU set type based on dynamic UL congestion level from the network node e.g. BS 704. As shown in FIG. 7, BS 704 is in CU-DU architecture, and includes DU 702 and CU 703. In Embodiment 3, following operations may be performed.

In operation 711, CU 703 sends the PDU set discard configuration (e.g., configuration #1 as described in the embodiments of FIG. 4) for a DRB, which carries data of PDU set type, to UE 701 in an RRC message, e.g., an RRCreconfiguration message, an RRCResume message, or an RRCSetup message.

In some embodiments, the PDU set discard configuration includes dynamicdiscardPDUSet IE, which is used to enable UE 701 to discard data of a PDU set which is of a PDU set type (e.g., unimportant) and available for transmission carried on a DRB if UE 701 receives the UL congestion level signalling which indicates that the UL congestion level is high or not low.

For example, the PDU set discard configuration may include a UL congestion level threshold to determine whether the UL congestion level is high or not low. The threshold may be predefined.

For example, the PDU set discard configuration may also include an indication, e.g., discardPDUSetInfo IE, which is used to indicate the PDU set type related to discard handling.

In operation 712, CU 703 may transmit an indication to DU 702 via F1AP message, to indicate that a transmission of a UL congestion level command or signalling is allowed or enabled. In operation 713, DU 702 may transmit the UL congestion level command or signalling (e.g., indication #1 as described in the embodiments of FIG. 4) to UE 701, to assist UE 701 to determine whether to start discarding data of a PDU set type. UL congestion level signalling may also be named as “UL congestion status signalling” or the like.

In some embodiments, when DU 702 detects that the UL congestion level is high or not low, DU 702 may determine to send the detected UL congestion level to UE 701. For instance, the UL congestion level may be enumerated with high or low or a numeric congestion level which varies from 0~1. For example, 1 represents the highest congestion level, 0.5 represents a middle congestion level, and 0 represents no congestion.

In operation 714, after UE 701 receives the UL congestion level signalling, UE 701 may activate discarding the PDU set of the PDU set type for a DRB if the UL congestion level is high or not low.

In operation 715, DU 702 may further transmit UL congestion level signalling (e.g., indication #2 as described in the embodiments of FIG. 4) to UE 701, to assist UE 701 to determine whether to stop discarding data of the PDU set type based on the updated/detected UL congestion level.

In operation 716, after UE 701 receives the UL congestion level signalling to deactivate the PDU set discarding for a DRB, UE 701 may stop discarding the PDU set type on the DRB if the updated UL congestion level is not high or low.

In some other embodiments of FIG. 7, the UL congestion level signalling in operation 713 and 715 may be replaced in-band marking, i.e., the UL congestion level is included in Layer2 (L2) header (e.g., SDAP/PDCP/RLC/MAC header) or an IP header.

### Embodiment 4

Embodiment 4 is similar to Embodiment 3. Embodiment 3 is applicable to Option 1 in FIG. 3. Embodiment 4 is applicable to Option 2 in FIG. 3. The operations 711, 712, 713, 715, and 716 performed in Embodiment 3 and Embodiment 4 are the same, but the operation 714 is different. Different from Embodiment 3, in operation 714 of Embodiment 4, if UE 701 receives the discard activation signalling from DU 702 to activate the PDU set discard for a DRB, UE 701 may start discarding the data of a specific PDU set type on the DRB. The specific PDU set type (e.g., PDU set #2) may be predefined by standard documents, configured by an RRC message or indicated by the dynamic signalling from a network node.

For example, in operation 714 of Embodiment 4, after receiving the discard activation signalling for the DRB, the MAC entity of UE 701 may notify the discard activation command to the PDCP entity of the DRB of UE 701. The PDCP entity may activate discarding PDCP SDU(s)/PDU(s) available for transmission of the PDU set type (e.g., PDU set type #2). The PDU set(s) of PDU set type #2 may include at least one of:
(1) The whole PDU set which has not been submitted to the RLC layer of UE 701.
(2) A part of the PDU set which has been submitted to the RLC layer of UE 701. In this case, the PDCP entity may notify the RLC entity (which carries the PDU set #2) to discard RLC SDU(s) of PDU set type #2, and/or the whole or a part of a RLC SDU of PDU set type #2 which has not been submitted to the MAC layer.

FIG. 8 illustrates an exemplary flowchart of a congestion handling enchantment mechanism in accordance with some embodiments of the present application. The exemplary flowchart 800 as shown in FIG. 8 may refer to different embodiments in different scenarios, i.e., Embodiment 5 as below. Embodiment 5 is applicable to Option 2 in FIG. 3.

### Embodiment 5

In Embodiment 5, the exemplary flowchart 800 shows an example of a PDU set discard operation based on the UL congestion level detection at a UE. In Embodiment 5, a network node (e.g., BS 804) needs to configure the UL congestion detection behavior and the UL congestion level determination criteria to trigger the PDU set discard operation at UE 801. In Embodiment 5, following operations may be performed.

In operation 811, CU 803 transmits the PDU set discard configuration (e.g., configuration #1 as described in the embodiments of FIG. 4) for a DRB, which carries data of a PDU set type, to UE 801 in an RRC message, e.g., an RRCreconfiguration message, an RRCResume message, or an RRCSetup message. For example, the PDU set discard configuration may include an indication, e.g., dynamicdiscardPDUSet IE, which is used to enable UE 801 to discard data of a PDU set that is of a PDU set type (e.g., unimportant) and available for transmission and carried on a DRB if UE 801 receives the UL congestion level signalling indicating that the UL congestion level is high or not low. UL congestion level signalling may also be named as “UL congestion status signalling” or the like.

For example, the PDU set discard configuration may also include an indication, e.g., discardPDUSetInfo IE, which is used to indicate the PDU set type related to discard handling.

In operation 812, CU 803 transmits the UL congestion detection configuration (e.g., configuration #2 as described in the embodiments of FIG. 4) to UE 801 in an RRC message, e.g., an RRCreconfiguration message, an RRCResume message, or an RRCSetup message. For example, the RRC message includes an indication, e.g., ULCongestionDectection IE, which is used to enable UE 801 to detect the UL congestion level.

In some embodiments, the ULCongestionDectection IE indicates the criteria of UL congestion level. For example, the criteria of the UL congestion level may include:
(1) A set of thresholds associated with detecting the UL congestion level, for instance:
   a) A threshold (denoted as threshold #1 for simplicity) for detecting whether the UL congestion level is high. Threshold #1 indicates the continuous discard count value of PDU set(s) on a DRB/an LCH or the continuous discard count value of PDCP SDU(s)/PDU(s) on a DRB/an LCH. UE 801 may count the continuous discard number of the PDU set or PDCP SDU/PDU on a DRB/an LCH, and if the count value is greater than or equal to threshold #1, UE 801 may consider that the UL congestion level is high or not low.
   b) A threshold (denoted as threshold #2 for simplicity) for detecting whether the UL congestion level is not high. Threshold #2 indicates the continuous discard count value of PDU set(s) on a DRB/an LCH or the continuous discard count value of PDCP SDU(s)/PDU(s) on a DRB/an LCH. UE 801 may count the continuous discard number of the PDU set or PDCP SDU/PDU on a DRB/an LCH, and if the count value is less than or equal to threshold #2, UE 801 may consider that the UL congestion level is not high or low.
(2) Length(s) of a set of timers associated with detecting the UL congestion level, for instance:
   a) A timer (denoted as timer #1 for simplicity) for detecting the UL congestion level is high. In some embodiments, timer #1 is for counting the continuous discard number of the PDU set(s) on a DRB or an LCH. The length of timer #1 may be N times of the transmission periodicity of the PDU set(s). In some other embodiments, timer #1 is for counting the continuous discard count value of PDCP SDU(s)/PDU(s) on a DRB or an LCH. The length of timer #1 may be N times of the transmission periodicity of the PDCP SDU(s)/PDU(s).
   b) A timer (denoted as timer #2 for simplicity) for detecting the UL congestion level is not high. In some embodiments, timer #2 is for counting the continuous discard number of PDU set(s) on a DRB/an LCH. The length of timer #2 may be N times of the transmission periodicity of the PDU set(s). In some other embodiments, timer #2 is for counting the continuous discard count value of PDCP SDU(s)/PDU(s) on a DRB/an LCH. The length of timer #2 may be N times of the transmission periodicity of the PDCP SDU(s)/PDU(s).
   c) The lengths of timer #1 and timer #2 may be the same or different.
(3) A PDU set buffer status of an LCH of the DRB or a logical channel group (LCG) including the LCH of the DRB, or a legacy buffer status of an LCG including the LCID of the DRB. For example, the PDU set buffer status may include:
   a) A threshold (denoted as threshold #3 for simplicity) for detecting whether the UL congestion level is high. Threshold #3 indicates a PDU set buffer status of an LCH of the DRB or an LCG including the LCH of the DRB or a legacy buffer status of an LCG including the LCID of the DRB. UE 801 may count the buffer size of the PDU set of an LCG or an LCH of the DRB or legacy buffer size of an LCG, and if the value is more than or equal to threshold #3, UE 801 may consider that the UL congestion level is high or not low.
   b) A threshold (denoted as threshold #4 for simplicity) for detecting the UL congestion level is not high. Threshold #4 indicates a PDU set buffer status of an LCH of the DRB or an LCG including the LCH of the DRB or a legacy buffer status of an LCG including the LCID of the DRB. UE 801 may count buffer size of the PDU set or legacy buffer size of an LCG, and if the value is less than or equal to threshold #4, UE 801 may consider that the UL congestion level is not high or low.
   c) Values of threshold #1, threshold #2, threshold #3, and threshold #4 may be the same or different.

In some other embodiments, the ULCongestionDectection IE may indicate the periodicity of detecting the UL congestion level.

In operation 813 (optional and marked as dotted line), CU 803 may transmit an indication to the DU 802 via F1AP message, to indicate that a transmission of a UL congestion detection command is allowed or enabled. In operation 814 (optional and marked as dotted line), DU 802 transmits a UL congestion detection command (e.g., command #2 as described in the embodiments of FIG. 4) to UE 801.

In some embodiments, the periodical detection of UL congestion level may be triggered by dynamic signalling from BS 804, e.g., a UL schedule retransmission of a transmission block (TB) including data of the DRB which is an implicit command, or an MAC CE to activate the UL congestion detect which is an explicit command.

In operation 815, UE 801 detects or monitors the UL congestion level according to the UL congestion detection configuration received in operation 812.

In operation 816, if UE 801 detects that the UL congestion level is high or not low, UE 801 activates the PDU set discard for a PDU set type on a DRB. Optionally, UE 801 may notify the UL congestion level or the PDU set discard status to DU 802 and/or CU 803.

In operation 817, if UE 801 detects that the UL congestion level is not high or low, UE 801 may stop discarding the PDU set type on the DRB. Optionally, UE 801 may notify the UL congestion level or the PDU set discard status to DU 802 and/or CU 803.

FIG. 9 illustrates an exemplary flowchart of transmitting configuration information regarding prioritizing a PDU set in accordance with some embodiments of the present application. The exemplary method 900 in the embodiments of FIG. 9 may be performed by a network node (e.g., BS 101, BS 704, or BS 804 as shown and illustrated in FIG. 1, FIG. 7, or FIG. 8). Although described with respect to a network node, it should be understood that other devices may be configured to perform a method similar to that of FIG. 9. Details described in all other embodiments of the present application are applicable for the embodiments of FIG. 9. Moreover, details described in the embodiments of FIG. 9 are applicable for all the embodiments of FIGS. 1-8 and 10-12. A specific example of exemplary method 900 is described in the embodiments of FIGS. 5A-5C, Embodiment 6 and Embodiment 7 in the embodiments of FIG. 7, and Embodiment 8 and Embodiment 9 in the embodiments of FIG. 8 as follows.

In the exemplary method 900 as shown in FIG. 9, in operation 901, a network node (e.g., BS 101 as shown in FIG. 1) receive capability information of a UE (e.g., UE 102a as shown in FIG. 1). The capability information includes prioritizing a type of PDU set. For example, the capability information supports a PDU set prioritization operation of the UE. For instance, the type of PDU set is carried on one LCH of multiple LCHs of a DRB or a DRB.

In operation 902, the network node may transmit, to the UE, configuration information (denoted as configuration #3 for simplicity) to prioritize the type of PDU set. For instance, configuration #3 may be included in RRC signalling. In some embodiments, configuration #3 indicates at least one of the following: an activated or deactivated status of prioritizing the type of PDU set; a PDU set type to be prioritized; or an importance level of a PDU set to be prioritized.

In some embodiments, the network node may transmit a command (denoted as command #3 for simplicity) to the UE, to activate or deactivate prioritizing the type of PDU set. In some embodiments, command #3 is included in a layer2 (L2) header, a MAC CE, a PDCP control PDU, an RLC control PDU, DCI, and/or RRC signalling. In some embodiments, command #3 includes at least one of the following:
(1) information for indicating the LCH or the DRB to apply command #3;
(2) an ID of the LCH; an ID of the DRB to activate or deactivate prioritizing the type of PDU set;
(3) an activated or deactivated status of prioritizing the type of PDU set;
(4) a PDU set type to be prioritized;
(5) an importance level of a PDU set to be prioritized;
(6) a time length of prioritizing the type of PDU set;
(7) an activated or deactivated status of prioritizing the type of PDU set carried on a DRB within one or more DRBs;
(8) a PDCP SN or a PDU set ID according to which prioritizing the type of PDU set is activated; or
(9) a PDCP SN or a PDU set ID according to which prioritizing the type of PDU set is deactivated.

In some embodiments, the network node may transmit configuration information (denoted as configuration #4 for simplicity) regarding detecting a UL congestion level to the UE. For instance, configuration #4 may be included in RRC signalling. In some embodiments, configuration #4 includes at least one of the following:
(1) an activated or deactivated status of detecting the UL congestion level;
(2) a set of thresholds associated with detecting the UL congestion level; or
(3) length(s) of a set of timers associated with detecting the UL congestion level.

In some embodiments, the network node may transmit to the UE an indication (e.g., denoted as indication #3 for simplicity) for indicating the UL congestion level which may be included in a layer2 (L2) header, a MAC CE, a SDAP control PDU, PDCP control PDU, an RLC control PDU, and/or an IP packet, and the UE may activate or deactivate prioritizing the type of PDU set based on such indication.

In some embodiments, the network node may transmit a command (denoted as command #4 for simplicity) to activate detecting the UL congestion level to the UE.

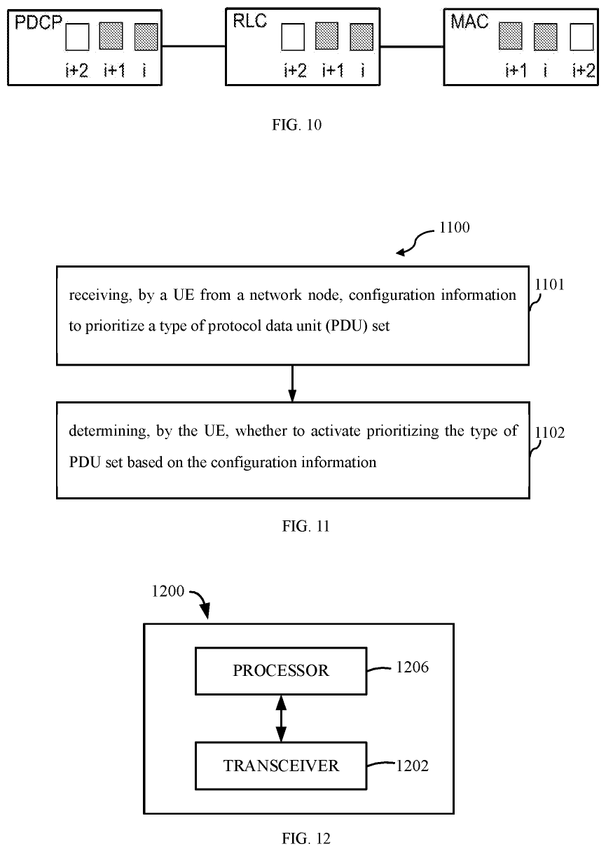

FIG. 10 illustrates an exemplary diagram of prioritizing a PDU set in accordance with some embodiments of the present application.

For example, after receiving the priority signalling (e.g., command #3 as described in the embodiments of FIG. 9) for a DRB, the MAC entity of a UE may activate prioritizing PDCP SDU(s) which is available for transmission and of a PDU set type during the MAC PDU assembly procedure or the enhanced (logical channel) prioritization procedure. In an example, regarding PDU sets orderly submitted to PDCP and RLC entities of the UE, e.g., the arrival order is PDU set i, PDU set i+1, and PDU set i+2 as shown in FIG. 10, the MAC entity of the UE may prioritize PDU set i+2 will be transmitted before the earlier arrival PDU set i and PDU set i+1.

FIG. 11 illustrates an exemplary flowchart of receiving configuration information regarding prioritizing a PDU set in accordance with some embodiments of the present application. The exemplary method 1100 in the embodiments of FIG. 11 may be performed by a UE (e.g., UE 102 as shown and illustrated in FIG. 1). Although described with respect to a UE, it should be understood that other devices may be configured to perform a method similar to that of FIG. 11. Details described in all other embodiments of the present application are applicable for the embodiments of FIG. 11. Moreover, details described in the embodiments of FIG. 11 are applicable for all the embodiments of FIGS. 1-10 and 12. Specific examples of exemplary method 1100 are described Embodiment 6 and Embodiment 7 in the embodiments of FIG. 7 and Embodiment 8 and Embodiment 9 in the embodiments of FIG. 8 as follows.

In the exemplary method 1100 as shown in FIG. 11, in operation 1101, a UE (e.g., UE 102a as shown in FIG. 1) may receive configuration information (e.g., configuration #3 as described in the embodiments of FIG. 9) to prioritize a type of PDU set from a network node (e.g., BS 101 as shown in FIG. 1). In some embodiments, the configuration information is received in RRC signalling. In operation 1102, the UE may determine whether to activate prioritizing the type of PDU set based on the configuration information. The type of PDU set is carried on an LCH or a DRB. For instance, the configuration information may include at least one of:
(1) an activated or deactivated status of prioritizing the type of PDU set;
(2) a PDU set type to be prioritized; or
(3) an importance level of a PDU set to be prioritized.

In some embodiments, the UE may receive a command (e.g., command #3 as described in the embodiments of FIG. 9) to activate or deactivate prioritizing the type of PDU set from the network node. The command may be included in a layer2 (L2) header, a MAC CE, a PDCP control PDU, an RLC control PDU, DCI, and/or RRC signalling. In some embodiments, the command includes at least one of the following:
(1) information for indicating the LCH or the DRB to apply the command;
(2) an ID of the LCH; an ID of the DRB to activate or deactivate prioritizing the type of PDU set;
(3) an activated or deactivated status of prioritizing the type of PDU set;
(4) a PDU set type to be prioritized;
(5) an importance level of a PDU set to be prioritized;
(6) a time length of prioritizing the type of PDU set;
(7) an activated or deactivated status of prioritizing the type of PDU set carried on a DRB within one or more DRBs;
(8) a PDCP SN or a PDU set ID according to which prioritizing the type of PDU set is activated; or
(9) a PDCP SN or a PDU set ID according to which prioritizing the type of PDU set is deactivated.

In some embodiments, in response to activating prioritizing the type of PDU set, the UE may perform at least one of the following:
(1) setting a higher priority to a PDU set (e.g., of PDU set type #1) carried on the DRB than another PDU set (e.g., of PDU set type #2) carried on the same DRB; or
(2) setting a lower priority to a PDU set (e.g., of PDU set type #2) carried on the DRB than another PDU set (e.g., of PDU set type #1) carried on the same DRB;
(3) setting a prioritize bit rate of PDU set type #2 with an original value to a new value; or
(4) setting bucket size duration of PDU set type #2 with an original value to a new value.

In some embodiments, in response to deactivating prioritizing the type of PDU set, the UE may perform at least one of the following:
(1) resetting the priorities of PDU set type #1 and/or PDU set type #2 to the original value;
(2) resetting the prioritize bit rate of PDU set type #2 to the original value; or
(3) resetting the bucket size duration of PDU set type #2 to the original value.

In some embodiments, the UE may receive, from the network node, an indication (e.g., indication #3 as described in the embodiments of FIG. 9) for indicating the UL congestion level which may be included in a layer2 (L2) header, a MAC CE, a SDAP control PDU, PDCP control PDU, an RLC control PDU, and/or an IP packet, and the UE may activate or deactivate prioritizing the type of PDU set based on such indication.

In some embodiments, the UE may receive configuration information (e.g., configuration #4 as described in the embodiments of FIG. 9) regarding detecting a UL congestion level from the network node. This configuration information is received in RRC signalling. In some embodiments, the configuration information includes at least one of the following:
(1) an activated or deactivated status of detecting the UL congestion level;
(2) a set of thresholds associated with detecting the UL congestion level; or
(3) length(s) of a set of timers associated with detecting the UL congestion level.

In some embodiments, the UE may receive a command (e.g., command #4 as described in the embodiments of FIG. 9) to activate detecting the UL congestion level from the network node.

In some embodiments, the UE may detect the UL congestion level based on the configuration information (e.g., configuration #4 as described in the embodiments of FIG. 9), and whether to activate prioritizing the type of PDU set is further determined based on the UL congestion level. In some embodiments, the UE may deactivate prioritizing the type of PDU set based on the UL congestion level.

It should be appreciated by persons skilled in the art that the sequence of the operations in any of exemplary flowcharts 900 and 1100 in FIGS. 9 and 11 described above may be changed and some of the operations in any of exemplary flowcharts 900 and 1100 in FIGS. 9 and 11 may be eliminated or modified, without departing from the spirit and scope of the disclosure.

In the embodiments of the present application, expressions of “configuring a PDU set type (e.g., PDU set type #1 or PDU set type #2) with a priority (e.g., a high or low priority)”, “setting a priority to data of a PDU set type”, and “setting a priority to a PDU set of a PDU set type” represent similar meanings. Expressions of “resetting a priority of a PDU set type (e.g., PDU set type #1 or PDU set type #2)”, “resetting a priority of data of a PDU set type”, and “resetting a priority of a PDU set of a PDU set type” represent similar meanings. Expressions of “resetting a priority bit rate of a PDU set type (e.g., PDU set type #1 or PDU set type #2)”, “resetting a priority bit rate of data of a PDU set type”, and “resetting a priority bit rate of a PDU set of a PDU set type” represent similar meanings. Expressions of “resetting bucket size duration of a PDU set type (e.g., PDU set type #1 or PDU set type #2)”, “resetting bucket size duration of data of a PDU set type”, and “resetting bucket size duration of a PDU set of a PDU set type” represent similar meanings.

Specific examples of the embodiments of FIGS. 9-11 will be illustrated in following text in combination with FIGS. 7 and 8, i.e., Embodiment 6, Embodiment 7, Embodiment 8, and Embodiment 9. Embodiment 6 and Embodiment 8 are applicable to Option 1 in FIG. 3. Embodiment 7 and Embodiment 9 are applicable to Option 2 in FIG. 3.

### Embodiment 6

In Embodiment 6, the exemplary flowchart 700 as shown in FIG. 7 shows an example of a PDU set prioritization operation based on the UL PDU set priority command from a network node, e.g., BS 704. In Embodiment 6, UE 701 may prioritize the transmission of a PDU set type based on an indication from BS 704.

In operation 711, CU 703 transmits the PDU set priority configuration (e.g., configuration #3 as described in the embodiments of FIG. 9) for a DRB (or an LCH), which carrying data of PDU set type, to UE 701 in RRC message. For example, the PDU set priority configuration includes an indication, e.g., priorityPDUSet IE, which is used to enable UE 701 to prioritize the data of an (important) PDU set(s) that is available for transmission carried on a DRB. In an example, BS 704 may configure PDU set type #1 with a high priority and PDU set type #2 with a low priority.

In operation 712, CU 703 may transmit an indication to DU 702 via F1AP message, to indicate that a transmission of a UL PDU set priority activation command or signalling is allowed or enabled. In operation 713, DU 702 transmits dynamic priority activation signalling (i.e., the UL PDU set priority activation signalling”, e.g., command #3 as described in the embodiments of FIG. 9) to UE 701, to assist UE 701 to determine to prioritize data of a PDU set type. In an example, when DU 702 detects that the UL congestion is high or not low, DU 702 may determine to sends the dynamic priority activation signalling to UE 701.

For example, the specific PDU set type, data of which is to be prioritized, may be predefined by standard documents, configured by RRC message or indicated by the dynamic signalling from BS 704. For example, the PDU set type can be importance level.

In operation 714, after UE 701 receives the PDU set priority activation signalling to activate the PDU set priority for a DRB (or an LCH), UE 701 may start prioritizing data of PDU set type #1 on the DRB, and set the prioritisedBitRate IE of PDU set type #2 to specific value #1, and/or set the bucketSizeDuration IE of PDU set type #2 to specific value #2. For example, specific value #1 or specific value #2 may be a preconfigured value, e.g., value 0, or may be configured by RRC signalling from BS 704.

In operation 715, DU 702 transmits dynamic PDU set priority deactivation signalling (e.g., command #3 as described in the embodiments of FIG. 9) to UE 701, to assist UE 701 to determine whether to stop prioritizing data of a PDU set type. In an example, when DU 702 detects that the UL congestion is not high or low, DU 702 may determine to send a PDU set priority deactivation command for a DRB to UE.

In operation 716, after UE 701 receives the dynamic PDU set priority deactivation signalling to deactivate the PDU set priority for a DRB, UE 701 may correspondingly stop prioritizing PDU set type #1 on the DRB and reset the prioritisedBitRate IE and/or bucketSizeDuration IE of PDU set type #2 to the original or previous value which is configured by BS 704.

In some embodiments similar to Embodiment 6, in operation 714, after UE 701 receives the PDU set priority activation signalling for a DRB, the MAC entity of UE 701 may start a timer and prioritizes the PDCP SDU available for transmission of PDU set type #1 till the timer expires. The length of the timer may be indicated in the “window length” field in the dynamic signalling (e.g., as described in FIGS. 5A-5C), preconfigured by RRC signalling from BS 704 or predefined in standard documents.

In some other embodiments similar to Embodiment 6, in operation 714, after UE 701 receives the PDU set priority activation signalling for a DRB, the MAC entity of UE 701 may prioritize the PDCP SDU available for transmission of PDU set type #1 only once.

In some other embodiments similar to Embodiment 6, in operation 713, instead of transmitting the dynamic priority activation signalling, DU 702 may transmit an indication (e.g., indication #3 as described in the embodiments of FIG. 9) for indicating a UL congestion level to UE 701. After receiving the indication, UE 701 may start prioritizing data of PDU set type #1 on the DRB and/or set the prioritisedBitRate IE of PDU set type #2 to a specific value if the received UL congestion level from DU 702 is high or not low. Otherwise, UE 701 may stop prioritizing the data of PDU set type #1 on the DRB, reset the prioritisedBitRate IE and/or bucketSizeDuration IE of PDU set type #2 to the original or previous value which is configured by BS 704.

### Embodiment 7

Embodiment 7 is similar to Embodiment 6. Embodiment 6 is applicable to Option 1 in FIG. 3. Embodiment 7 is applicable to Option 2 in FIG. 3. The operations 711, 712, 713, and 715 performed in Embodiment 6 and Embodiment 7 are the same, but the operations 714 and 716 are different. Different from Embodiment 6, in operation 714 of Embodiment 7, after UE 701 receives the PDU set priority activation signalling, UE 701 may update/apply the priority of one LCH of multiple LCHs for a DRB so that the priority of the LCH to carry PDU set type #1 is higher than PDU set type #2, and/or set the prioritisedBitRate IE and/or bucketSizeDuration IE of the LCH carrying PDU set type #2 to a specific value in order to limit the transmission bit rate of the PDU set type #2, In operation 716, UE 701 may reset the LCH priority of the LCH carrying PDU set type #1 and/or PDU set type #2 to the original or previous value to resume the LCH priority, and/or reset the prioritisedBitRate IE and/or bucketSizeDuration IE of the LCH carrying PDU set type #2 to the original or previous value to resume the transmission bit rate of the PDU set type #2.

### Embodiment 8

In Embodiment 8, the exemplary flowchart 800 as shown in FIG. 8 shows an example of a PDU set prioritization operation based on the UL congestion level detection at UE. In some embodiments of FIG. 8, UE 801 may prioritize the transmission of a PDU set type based on the UL congestion level detected at UE 801.

In operation 811, CU 803 transmits the PDU set priority configuration (e.g., configuration #3 as described in the embodiments of FIG. 9) for one DRB (or one LCH), which carrying data of a PDU set type, to UE 801 in an RRC message. For example, the PDU set priority configuration includes an indication, e.g., priorityPDUSet IE, which is used to enable UE 801 to prioritize data of (important) PDU set(s) that is available for transmission carried on a DRB. In an example, the network configures PDU set type #1 with a high priority and PDU set type #2 with a low priority.

In operation 812, CU 803 transmits the UL congestion detection configuration (e.g., configuration #4 as described in the embodiments of FIG. 9) to UE 801 in an RRC message, e.g., an RRCreconfiguration message, an RRCResume message, or an RRCSetup message. For example, the RRC message includes an indication, e.g., ULCongestionDectection IE, which is used to enable UE 801 to detect the UL congestion level. The UL congestion detection configuration may be the same as the UL congestion detection configuration (e.g., the ULCongestionDectection IE) in operation 812 of Embodiment 5 as described above, including timer #1, timer #2, threshold #1, threshold #2, threshold #3, and threshold #4.

In operation 813 (optional and marked as dotted line), CU 803 may transmit an indication to the DU 802 via F1AP message, to indicate that a transmission of a UL congestion detection command is allowed or enabled. In operation 814 (optional and marked as dotted lines), DU 802 transmits a UL congestion detection command (e.g., command #4 as described in the embodiments of FIG. 9) to UE 801.

In operation 815, UE 801 detects or monitors the UL congestion level according to the UL congestion detection configuration received in operation 812.

In operation 816, if UE 801 detects that the UL congestion level is high or not low, UE 801 may activate the PDU set prioritizing for PDU set type #1 on a DRB and/or set the prioritisedBitRate IE and/or bucketSizeDuration IE of PDU set type #2 to a specific value.

In operation 817, if UE 801 detects that the UL congestion level is not high or low, UE 801 may stop prioritizing PDU set type #1 on the DRB and reset the prioritisedBitRate IE and/or bucketSizeDuration IE of PDU set type #2 to the original or previous value which is configured by BS 804.

### Embodiment 9

Embodiment 9 is similar to Embodiment 8. Embodiment 8 is applicable to Option 1 in FIG. 3. Embodiment 9 is applicable to Option 2 in FIG. 3. The operations 811 to 815 performed in Embodiment 8 and Embodiment 9 are the same, but the operations 816 and 817 are different. Different from Embodiment 8, in operation 816 of Embodiment 9, after UE 801 detects that the UL congestion level is high or not low in operation 815, UE 801 may updates the priority of one of multiple LCHs for a DRB and/or set the prioritisedBitRate IE and/or bucketSizeDuration IE of the LCH carrying PDU set type #2 to a specific value, wherein the priority of the LCH to carry PDU set type #1 is higher than or equal to the priority of the LCH to carry PDU set type #2. In operation 817 of Embodiment 9, UE 801 may reset the LCH priority of PDU set type #1 and PDU set type #2 to the original or previous value, and/or reset the prioritisedBitRate IE and/or bucketSizeDuration IE of the LCH carrying PDU set type #2 to the original or previous value.

FIG. 12 illustrates a block diagram of an exemplary apparatus 1200 in accordance with some embodiments of the present application. As shown in FIG. 12, the apparatus 1200 may include at least one processor 1206 and at least one transceiver 1202 coupled to the processor 1206. Although in this figure, elements such as the at least one transceiver 1202 and processor 1206 are described in the singular, the plural is contemplated unless a limitation to the singular is explicitly stated. In some embodiments of the subject application, the transceiver 1202 may be divided into two devices, such as a receiving circuitry and a transmitting circuitry. In some embodiments of the subject application, the apparatus 1200 may further include an input device, a memory, and/or other components.

In some embodiments of the subject application, the apparatus 1200 may be a UE or a network node (e.g., a BS). The transceiver 1202 and the processor 1206 may interact with each other so as to perform the operations with respect to the UE or the network node described above, for example, in any of FIGS. 1-11.

In some embodiments of the subject application, the apparatus 1200 may further include at least one non-transitory computer-readable medium. For example, in some embodiments of the present disclosure, the non-transitory computer-readable medium may have stored thereon computer-executable instructions to cause the processor 1206 to implement the method with respect to a UE or a network node (e.g., a BS) as described above. For example, the computer-executable instructions, when executed, cause the processor 1206 interacting with transceiver 1202 to perform the operations with respect to the UE or the network node described in FIGS. 1-11.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”. Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the subject application, but is not used to limit the substance of the subject application.

1. A network node, comprising:
at least one memory; and
at least one processor coupled with the at least one memory and configured to cause the network node to:
receive capability information of a user equipment (UE), wherein the capability information includes discarding a type of protocol data unit (PDU) set or detecting an uplink (UL) congestion level; and
transmit, to the UE, first configuration information to discard the type of PDU set within multiple types of PDU sets.

2. The network node of claim 1, wherein the first configuration information indicates at least one of the following:
an activated or deactivated status of discarding the type of PDU set;
a PDU set type to be discarded; or
an importance level of a PDU set to be discarded.

3. The network node of claim 1, wherein the at least one processor is configured to cause the network node to transmit a first command to the UE to activate or deactivate discarding the type of PDU set.

4. The network node of claim 3, wherein the first command includes at least one of the following:
information for indicating a logical channel (LCH) or a data radio bearer (DRB) to apply the first command;
an identifier (ID) of the LCH;
an ID of the DRB;
an activated or deactivated status of discarding the type of PDU set;
a PDU set type to be discarded;
an importance level of a PDU set to be discarded;
a time length of discarding the type of PDU set;
an activated or deactivated status of discarding the type of PDU set carried on a DRB within one or more DRBs;
a first packet data convergence protocol (PDCP) sequence number (SN) or a first PDU set ID according to which discarding the type of PDU set is activated; or
a second PDCP SN or a second PDU set ID according to which discarding the type of PDU set is deactivated.

5. The network node of claim 1, wherein the processor is configured to cause the network node to:
detect a UL congestion level; and
transmit a first indication for indicating the UL congestion level to the UE.

6. The network node of claim 1, wherein the processor is configured to cause the network node to transmit second configuration information regarding detecting the UL congestion level to the UE.

7. The network node of claim 6, wherein the second configuration information includes at least one of the following:
an activated or deactivated status of detecting the UL congestion level;
a set of thresholds associated with detecting the UL congestion level; or
one or more lengths of a set of timers associated with detecting the UL congestion level.

8. The network node of claim 6, wherein the at least one processor is configured to cause the network node to transmit a command to activate detecting the UL congestion level to the UE.

9. A user equipment (UE), comprising:
at least one memory; and
at least one processor coupled with the at least one memory and configured to cause the UE to:
receive, from a network node, first configuration information to discard a type of protocol data unit (PDU) set within multiple types of PDU sets; and
determine whether to activate discarding the type of PDU set based on the first configuration information.

10. The UE of claim 9, wherein the first configuration information indicates at least one of the following:
an activated or deactivated status of discarding the type of PDU set;
a PDU set type to be discarded; or
an importance level of a PDU set to be discarded.

11. The UE of claim 9, wherein the at least one processor is configured to cause the UE to receive a first command to activate or deactivate discarding the type of PDU set from the network node.

12. The UE of claim 11, wherein the first command includes at least one of the following:
information for indicating a logical channel (LCH) or a data radio bearer (DRB) to apply the first command;
an identifier (ID) of the LCH;
an ID of the DRB;
an activated or deactivated status of discarding the type of PDU set;
a PDU set type to be discarded;
an importance level of a PDU set to be discarded;
time length of discarding the type of PDU set;
an activated or deactivated status of discarding the type of PDU set carried on a DRB within one or more DRBs;
a first packet data convergence protocol (PDCP) sequence number (SN) or a first PDU set ID according to which discarding the type of PDU set is activated; or
a second PDCP SN or a second PDU set ID according to which discarding the type of PDU set is deactivated.

13. The UE of claim 9, wherein, in response to activating discarding the type of PDU set, the at least one processor is configured to cause a PDCP entity of the UE to discard at least one of the following:
a first PDU set not submitted to one or more RLC entities of the UE; or
a second PDU set a part of which has been submitted to the one or more RLC entities of the UE.

14. A network node, comprising:
at least one memory; and
at least one processor coupled with the at least one memory and configured to cause the network node to:
receive capability information of a user equipment (UE), wherein the capability information includes prioritizing a type of protocol data unit (PDU) set; and
transmit, to the UE, first configuration information to prioritize the type of PDU set.

15. The network node of claim 14, wherein the first configuration information indicates at least one of the following:
an activated or deactivated status of prioritizing the type of PDU set;
a PDU set type to be prioritized; or
an importance level of a PDU set to be prioritized.

16. A processor for wireless communication, comprising:
at least one controller coupled with at least one memory and configured to cause the processor to:
receive, from a network node, first configuration information to discard a type of protocol data unit (PDU) set within multiple types of PDU sets; and
determine whether to activate discarding the type of PDU set based on the first configuration information.

17. The processor of claim 16, wherein the first configuration information indicates at least one of the following:
an activated or deactivated status of discarding the type of PDU set;
a PDU set type to be discarded; or
an importance level of a PDU set to be discarded.

18. The processor of claim 16, wherein the at least one controller is configured to cause the processor to receive a first command to activate or deactivate discarding the type of PDU set from the network node.

19. The processor of claim 18, wherein the first command includes at least one of the following:
information for indicating a logical channel (LCH) or a data radio bearer (DRB) to apply the first command;
an identifier (ID) of the LCH;
an ID of the DRB;
an activated or deactivated status of discarding the type of PDU set;
a PDU set type to be discarded;
an importance level of a PDU set to be discarded;
time length of discarding the type of PDU set;
an activated or deactivated status of discarding the type of PDU set carried on a DRB within one or more DRBs;
a first packet data convergence protocol (PDCP) sequence number (SN) or a first PDU set ID according to which discarding the type of PDU set is activated; or
a second PDCP SN or a second PDU set ID according to which discarding the type of PDU set is deactivated.

20. The processor of claim 16, wherein, in response to activating discarding the type of PDU set, the at least one controller is configured to cause a PDCP entity of the processor to discard at least one of the following:
a first PDU set not submitted to one or more RLC entities of the processor; or
a second PDU set a part of which has been submitted to the one or more RLC entities of the processor.
